(19) United States
(12) Patent Application Publication
(10) Pub. No.: US 2025/0354332 A1
(43) Pub. Date: Nov. 20, 2025

(54) COATED PAPER ARTICLE

(71) Applicant: Dow Global Technologies LLC, Midland, MI (US)

(72) Inventors: Hanze Ying, Midland, MI (US); David L. Malotky, Midland, MI (US); Ray E. Drumright, Midland, MI (US); Jonathan F. Mason, Midland, MI (US); Luqing Qi, Midland, MI (US); Bernhard U. Kainz, Lauf (DE)

(21) Appl. No.: 18/871,854

(22) PCT Filed: Jun. 2, 2023
(86) PCT No.: PCT/US2023/067807

§ 371 Date: Dec. 5, 2024

Related U.S. Application Data
(60) Provisional application No. 63/350,552, filed on Jun. 9, 2022.

(51) Int. Cl. D21H 19/22; C09D 123/02

(52) U.S. Cl. CPC D21H 19/22; C09D 123/02

(57) ABSTRACT

The present invention relates to an article comprising paper superposed with a coating comprising a poly-C₂-C₃-olefin. a dispersant, and a C₅-C₂₆-alkyl primary fatty amide: wherein the coating has a coat weight in the range of from 1 g/m² to 20 g/m². The article of the present invention has desirable moisture vapor transition rate and coefficient of friction properties.

### BACKGROUND OF THE INVENTION

The present invention relates to a coated paper article, more particularly a paper substrate coated with a polyolefin coating. The coated paper substrate has been found to have useful moisture vapor transmission rate properties.

Consumer demand for sustainable paper used in packaging is fueling interest in improving barrier properties and recyclability of coated paper. Barrier performance of paper is known to be enhanced with polyolefin coatings, which also provide heat-seal properties; still, attaining a coating areal density (coat weight) of <10 g/m² by application of an extruded polyolefin layer onto a paper substrate has been elusive. Achieving these ultra-low coat weights is especially important in flexible packaging applications, where paper substrates have a paper areal density (basis weight) of <60 g/m², and where the market requires >85 wt % fiber recycling based on the mass of the article.

As disclosed in U.S. Pat. No. 10,612,193 B2 (col. 2, Table 2) ultra-thin coatings can be prepared by applying a waterborne polyolefin emulsion onto the paper substrate, followed by curing; nevertheless, meeting targets for moisture vapor transmission rate (MVTR) and coefficient of friction (CoF) remain elusive. Accordingly, it would be an advance in the field of coated paper substrates to prepare a thin coating that meets the application requirements for MVTR and provides a recyclable package.

### SUMMARY OF THE INVENTION

The present invention addresses a need in the art by providing an article comprising paper superposed with a dry coating comprising a poly-C₂-C₃-olefin, a dispersant, and a C₅-C₂₆-alkyl primary fatty amide; wherein the coating has a coat weight in the range of from 1 g/m² to 20 g/m². The article of the present invention has advantageous moisture vapor transmission rate and coefficient of friction properties.

### DETAILED DESCRIPTION OF THE INVENTION

The present invention is an article comprising paper superposed with a dry coating comprising a poly-C₂-C₃-olefin, a dispersant, and a C₅-C₂₆-alkyl primary fatty amide; wherein the coating has a coat weight in the range of from 1 g/m² to 20 g/m². The article of the present invention has advantageous moisture vapor transmission rate and coefficient of friction properties.

As used herein, “poly-C₂-C₃-olefin” refer to polyethylene, polypropylene, and poly(ethylene-propylene) copolymers. The polyethylene may be an ethylene-C₄-C₁₀-α-olefin copolymer (i.e., linear low-density polyethylene) such as an ethylene-1-butene copolymer, an ethylene-1-hexene copolymer, and an ethylene-1-octene copolymer. A commercially available linear low-density polyethylene is AFFINITY PL1280 LLDPE Ethylene-Octene Copolymer (A Trademark of The Dow Chemical Company or its Affiliates). The polyethylene may also be a high-density polyethylene, commercially available, for example, as DOW™ DMDA-8940 NT 7 HDPE Resin; or a low-density polyethylene. An example of a commercially available ethylene-propylene copolymer is VERSIFY™ 4200 Propylene-Ethylene Copolymer (Trademarks of The Dow Chemical Company or its Affiliates), and a commercially available polypropylene is Braskem 6D43 Random Copolymer.

The article of the present invention is conveniently prepared by applying a wet coating of a composition, preferably having a pH in the range of from 8 to 11, comprising an aqueous dispersion of poly-C₂-C₃-olefin particles, a dispersant, and a C₅-C₂₆-alkyl primary fatty amide to paper, then drying the wet coating, preferably at elevated temperatures to drive off water.

The poly-C₂-C₃-olefin particles, which are believed to contain the C₂-C₃-polyolefin and some amount of the dispersant and the primary fatty amide associated therewith, preferably have a volume mean particle size in the range of from 200 nm or from 300 nm to 5 μm or to 3 μm or to 1.5 μm, as measured by dynamic light scattering.

The dispersant is a copolymer of ethylene and a carboxylic acid monomer or a salt thereof. Examples of suitable dispersants include lithium, sodium, and potassium salts of ethylene-acrylic acid copolymers, ethylene-methacrylic acid copolymers, and ethylene-itaconic acid copolymers.

The weight-to-weight ratio of structural units of ethylene to carboxylic acid monomer is preferably in the range of from 95:5, more preferably from 90:10, and most preferably from 85:15; to 70:30, more preferably to 75:25. As used herein, the term “structural unit” of the named monomer refers to the remnant of the monomer after polymerization. For example, a structural unit of methacrylic acid is as illustrated:

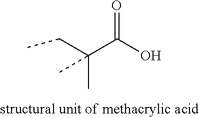

where the dotted lines represent the points of attachment of the structural unit to the polymer backbone.

Examples of commercially available dispersants include PRIMACOR™ 5980i Ethylene-Acrylic Acid Copolymer and NUCREL 960™ Ethylene-Methacrylic Acid Copolymer (Trademarks of The Dow Chemical Company or its Affiliates).

The C₅-C₂₆-alkyl primary fatty amide may be linear or branched and may be saturated or partially unsaturated with one or two or three double bonds. The fatty amide may also be a C₁₀-C₂₄-alkyl primary fatty amide or a C₁₆-C₂₂-alkyl primary fatty amide. Examples of suitable fatty amides include linear and branched C₁₈-alkyl mono-unsaturated fatty amides; linear and branched C₁₈-alkyl saturated fatty amides; linear and branched C₂₂-alkyl mono-unsaturated fatty amides; and linear and branched C₂₂-alkyl saturated fatty amides. The C₅-C₂₆-alkyl primary fatty amide preferably has a melting point in the range of from 50° C. or from 65° C. to 115° C. or to 100° C. or to 90° C.

The concentration of the poly-C₂-C₃-olefin in the coating is preferably in the range of from 40 or from 60 or from 70 weight percent, to 95 or to 90 weight percent, based on the weight of the polyolefin, the dispersant, and the C₅-C₂₆-alkyl primary fatty amide. The concentration of the dispersant is preferably in the range of from 4 or from 9, or from 15 weight percent, to 50, or to 40, or to 30 weight percent, based on the weight of the polyolefin particles, the dispersant, and the C₅-C₂₆-alkyl fatty amide. The concentration of the C₅-C₂₆-alkyl primary fatty amide is preferably in the range of from 0.5 or from 1 to 5 or to 4 or to 3 weight percent, based on the weight of the polyolefin particles, the dispersant, and the C₅-C₂₆-alkyl fatty amide.

The pH of the composition used to prepare the article can be adjusted to the desired level by addition of a neutralizing agent such as KOH.

The composition advantageously further comprises a stabilizing amount of an anionic surfactant such as a C₁₀-C₂₄ linear or branched alkyl or aralkyl carboxylate, sulfate, or phosphate; or a nonionic surfactant such as a secondary alcohol ethoxylate or an ethylene oxide propylene oxide block copolymer surfactant. The composition can be prepared as shown in the Examples section. The article is advantageously prepared by applying the composition to a paper substrate with a drawdown bar, followed by removal of water, preferably at advanced temperatures as described in the next section.

It has been discovered that coat weights in the range of 1 g/m², or from 2 g/m² or from 5 g/m² to 20 g/m² or to 12 g/m² or to 10 g/m² can be achieved with desirable moisture vapor transmission rate (MVTR) and coefficient of friction (CoF) properties.

### Method for Preparing Coated Substrates and Measuring Coat Weights

UPM Brilliant 62 Glassine Paper (basis wt. 62 g/m²) was coated with the polyolefin dispersion using a drawdown bar and dried in a forced air oven for 2 min at 100° C. to a final coating areal density (coat weight) of 8 g/m² (˜8 to 9 μm coating thickness). Coat weights were measured by punching holes in coated and uncoated UPM paper with a circular die to form discs having a specified diameter (D cm). The coated discs (W1) were weighed against the uncoated disc (W2) and the coat weights were calculated by the formula:

$$\frac{( W 1 - W 2 )}{π \times {( \frac{D}{200} )}^{2}}$$

### Moisture Vapor Transmission Rate Measurements

Moisture Vapor Transmission Rates (MVTRs) were determined in accordance with ASTM E96/E96M. A coated paper sample was sealed to the open end of a permeability cup followed by exposure of the sample to a controlled temperature and humidity environment (typically, a humidity chamber). MVTR was determined based by measuring mass uptake for the cup as a function of time.

### Dynamic Coefficient of Friction Measurements

The dynamic coefficients of friction (CoFs) were measured using a Texture Analyzer with a sliding friction rig in accordance with TAPPI T549. A piece of coated paper was affixed to the bottom of a sled weighing 200 g with the coated side facing down. Another piece of coated paper was affixed to a plane with coated side facing up. A string was attached to the sled and pulled so that the sled traversed the plane at the speed of 2.5 mm/s for at least 100 mm. The plateaued force Fd (unit: gram force) for the constant moving of the sled was recorded. Dynamic CoFs were calculated as Fd/200.

### Measurement of Degree of Neutralization

The degree of neutralization of the polyolefin dispersions was determined by the following equation:

$$D o N = \frac{56000 \times W}{{E}_{B} {\sum }_{i} {A}_{i} {ω}_{i}} \times 100$$

where W is the weight of the base added in g, E_{B} is the equivalent weight of the base, Aᵢ is the acid number of the ith component in units of mg KOH/g and the ωᵢ is the weight fraction of the ith component in POD dispersion solid.

### EXAMPLES

Table 1 illustrates the components and feed rates used to prepare Examples 1-4 and Comparative Examples 1-5. Feed rates are shown parenthetically. The general procedure is shown following Table 1. PO refers to the polyolefin; Amide refers to the fatty amide; H₂Oₒ refers to the initial water rate; H2O_{d} refers to the dilution water rate; Solids refers to the wt. % solids of the polyolefin the dispersant, the fatty amide, and the anionic surfactant in the dispersion; and PS refers to the particle size of the particles in microns as determined by dynamic light scattering.

PL1280 refers to AFFINITY™ PL 1280 LLDPE Ethylene-Octene Copolymer; V4200 refers to VERSIFY™ Ethylene-Propylene Copolymer; N960 refers to NUCREL™ N960 Ethylene-Methacrylic Acid Copolymer. OA (Oleamide, m.p. 70° C.) is a C₁₈-alkyl mono-unsaturated primary fatty amide; EA (Euracamide, m.p 80° C.) is a C₂₂-alkyl mono-unsaturated primary fatty amide; BA (behenamide, m.p. 112° C.) is a C₂₂-alkyl saturated primary fatty amide; EBS (ethylene bis-stearamide, m.p. 145° C.) is a C₃₈-alkyl secondary fatty amide; OPA (oleyl palmitamide, m.p. 60-66° C.) is a C₃₄-alkyl secondary fatty amide; SEA (stearyl 5uracamide, m.p. 70-75° C.) is a C₄₀-alkyl secondary fatty amide.

The degree of neutralization for Comparative Examples 1-4 and Examples 1-6 was 75% and the degree of neutralization for Comparative Example 5 and Example 7 was 80%.

TABLE 1
Components and Feed Rates for Examples

| | PO | | N960 | Amide | | H₂Oₒ | KOH | H₂O_{d} | Solids | PS |
|---|---|---|---|---|---|---|---|---|---|---|
| Ex. No. | (g/min) | | (g/min) | (g/min) | | (mL/min) | (mL/min) | (mL/min) | (wt. %) | (μm) |
| Comp. 1 | PL1280 | (61.3) | (11.4) | None | | (7.9) | (3.3) | (80) | 47.8 | 0.41 |
| Ex. 1 | PL1280 | (60.2) | (11.4) | OA | (1.1) | (7.9) | (3.3) | (80) | 48.2 | 0.56 |
| Ex. 2 | PL1280 | (59) | (11.4) | OA | (2.3) | (7.9) | (3.3) | (80) | 49.2 | 0.86 |
| Ex. 3 | PL1280 | (60.2) | (11.4) | EA | (1.1) | (7.9) | (3.3) | (80) | 48.4 | 0.57 |
| Ex. 4 | PL1280 | (59) | (11.4) | EA | (2.3) | (7.9) | (3.3) | (80) | 48.8 | 1.44 |
| Ex. 5 | PL1280 | (60.2) | (11.4) | BA | (1.1) | (7.9) | (3.3) | (80) | 48.4 | 0.55 |
| Ex. 6 | PL1280 | (59) | (11.4) | BA | (2.3) | (7.9) | (3.3) | (80) | 48.3 | 1.21 |
| Comp. 2 | PL1280 | (60.2) | (11.4) | EBS | (1.1) | (7.9) | (3.3) | (80) | 48.0 | 0.56 |
| Comp. 3 | PL1280 | (60.1) | (11.3) | OPA | (1.1) | (7.9) | (3.3) | (79) | 49.1 | 0.45 |
| Comp 4 | PL1280 | (59.0) | (11.3) | SEA | (1.1) | (7.9) | (3.3) | (77) | 49.5 | 0.41 |
| Ex. 7 | V4200 | (59.8) | (11.4) | EA | (1.5) | (9.2) | (3.1) | (80) | 49.1 | 1.32 |

| | | | | | | | | | |
|---|---|---|---|---|---|---|---|---|---|
| Comp. 5 | V4200 | (61.3) | (11.4) | None | (7.9) | (3.5) | (85) | 47.7 | 0.52 |

### General Procedure for Preparation of Aqueous Dispersions of Polyolefin Dispersions

Aqueous dispersions were prepared by the following general procedure:

The PO, N960, and the Amide (except for Comparative Examples 1 and 5) were fed into a 25-mm diameter twin screw extruder using separate controlled rate feeders. The anionic surfactant (Oleic acid) was pumped into the melt zone of the extruder as a liquid using an Isco syringe pump at a feed rate of 3.4 mL/min. The PO, N960, and the Amide were forwarded through the extruder and melted to form an intermediate liquid melt material.

The extruder temperature profile was ramped up to 150° C. Water and 30% aq. KOH were mixed and fed to the extruder at an initial water introduction site after a uniform polymer melt was formed; then, dilution water was fed into the extruder. The extruder speed was 450 rpm for all samples except Comparative Example 5, where the extruder speed was 400 rpm. At the extruder outlet, a backpressure regulator was used to adjust the pressure inside the extruder barrel to a pressure adapted to reduce steam formation, generally in the range of 2 MPa to 4 MPa.

Each aqueous dispersion exited from the extruder and was filtered first through a 200-μm filter. The solids content of dispersions was measured using an infrared solids analyzer, and the volume mean particle size of the polymer particles was measured using a COULTER™ LS-230 particle size analyzer (Beckman Coulter Corporation, Fullerton, CA).

Table 2 illustrates the MVTR and CoF for the examples and comparative examples. The coating thicknesses for each sample was 8 gsm. PO:N960:Amide refers to the w/w/w ratios of the polyolefin, the dispersant, and the fatty amide.

TABLE 2
MVTR and CoF of Samples

| | | Amide m.p. | 1° or | | CoF |
|---|---|---|---|---|---|
| Ex No. | PO:N960:Amide | ° C. | 2° | MVTR | dynamic |
| Comp. 1 | 84.4:15.6:0 | none | NA | 185.3 | 0.29 |
| Ex. 1 | 82.8:15.6:1.6 | 70 | 1° | 124 | 0.07 |
| Ex. 2 | 81.2:15.6:3.2 | 70 | 1° | 92 | 0.07 |
| Ex. 3 | 82.8:15.6:1.6 | 80 | 1° | 146.3 | 0.09 |
| Ex. 4 | 81.2:15.6:3.2 | 80 | 1° | 88.6 | 0.10 |
| Ex. 5 | 82.8:15.6:1.6 | 112 | 1° | 125 | 0.29 |
| Ex. 6 | 81.2:15.6:3.2 | 112 | 1° | 89.1 | 0.3 |
| Comp. 2 | 82.8:15.6:1.6 | 145 | 2° | 193 | 0.36 |
| Comp. 3 | 82.8:15.6:1.6 | 60-66 | 2° | 191.9 | 0.11 |
| Comp. 4 | 82.8:15.6:1.6 | 70-75 | 2° | 195.9 | 0.15 |
| Ex. 7 | 82.8:15.6:1.6 | 80 | 1° | 103 | 0.06 |
| Comp. 5 | 84.4:15.6:0 | none | NA | 143 | 1.35 |

The data show an improvement in MVTR for coatings containing primary fatty amides when compared with coatings containing either no amide additive or coatings containing secondary fatty amides. For certain applications, dynamic CoFs of 0.3 or less are acceptable; for other applications, CoFs of less than 0.2 are required.

1. An article comprising paper superposed with a coating comprising a poly-C₂-C₃-olefin, a dispersant, and a C₅-C₂₆-alkyl primary fatty amide; wherein the coating has a coat weight in the range of from 1 g/m² to 20 g/m².

2. The article of claim 1 wherein, based on the weight of the poly-C₂-C₃-olefin, the dispersant, and the C₅-C₂₆-alkyl primary fatty amide, the concentration of the polyolefin is in the range of from 40 to 95 weight percent; the concentration of the dispersant is in the range of from 4 to 50 weight percent; and the concentration of the C₅-C₂₆-alkyl primary fatty amide is in the range of from 0.5 to 5 weight percent.

3. The article of claim 2 wherein the dispersant is a salt of an ethylene-acrylic acid copolymer or a salt of an ethylene-methacrylic acid copolymer; and the C₅-C₂₆-alkyl primary fatty amide is a C₁₀-C₂₄-alkyl primary fatty amide; and wherein the coating has a coat weight in the range of from 5 g/m² to 10 g/m².

4. The article of claim 3 wherein the C₁₀-C₂₄-alkyl primary fatty amide is a C₁₆-C₂₂-alkyl primary fatty amide having a melting point in the range of from 50° C. to 115° C., and the poly-C₂-C₃-olefin is an ethylene-C₄-C₁₀-α-olefin copolymer.

5. The article of claim 4 wherein the ethylene-C₄-C₁₀-α-olefin copolymer is an ethylene-1-octene copolymer.

6. The article of claim 3 wherein the C₁₀-C₂₄-alkyl primary fatty amide is a C₁₆-C₂₂-alkyl primary fatty amide having a melting point in the range of from 50° C. to 115° C., and the poly-C₂-C₃-olefin is a polypropylene.

7. The article of claim 3 wherein the C₁₀-C₂₄-alkyl primary fatty amide is a C₁₆-C₂₂-alkyl primary fatty amide having a melting point in the range of from 50° C. to 115° C., and the poly-C₂-C₃-olefin is a poly (ethylene-propylene) copolymer.

8. The article of claim 2 wherein, based on the weight of the poly-C₂-C₃-olefin, the dispersant, and the C₅-C₂₆-alkyl primary fatty amide, the concentration of the poly-C₂-C₃-olefin is in the range of from 60 to 90 weight percent; the concentration of the dispersant is in the range of from 9 to 40 weight percent; and the concentration of the C₅-C₂₆-alkyl primary fatty amide is in the range of from 1 to 4 weight percent.

9. The article of claim 4 wherein, based on the weight of the poly-C₂-C₃-olefin, the dispersant, and the C₁₆-C₂₂-alkyl primary fatty amide, the concentration of the poly-C₂-C₃-olefin is in the range of from 60 to 90 weight percent; the concentration of the dispersant is in the range of from 9 to 40 weight percent; and the concentration of the C₁₆-C₂₂-alkyl primary fatty amide is in the range of from 1 to 4 weight percent.
